(19) United States
(12) Patent Application Publication
(10) Pub. No.: US 2013/0342048 A1
(43) Pub. Date: Dec. 26, 2013

(54) METHOD OF MANUFACTURING A LAMINATED WINDING AND A LAMINATED WINDING

(71) Applicant: Conny HOGMARK, Helsingborg (SE)

(72) Inventor: Conny HOGMARK, Helsingborg (SE)

(21) Appl. No.: 13/922,292

(22) Filed: Jun. 20, 2013

(30) Foreign Application Priority Data
Jun. 21, 2012 (SE) 1200375-2

(51) Int. Cl. H02K 3/12; H02K 15/04

(52) U.S. Cl. CPC H02K 3/12; H02K 15/0435
USPC 310/58; 29/605; 310/195

(57) ABSTRACT

A method of producing a cylindrical laminated winding with radial slots for electrical machines is disclosed. The method includes providing a strip of conducting material, cutting cuts in a strip where the cuts form the radial slots of the laminated winding, and winding the strip to form the cylindrical laminated winding whereby a radial distance is enclosed between adjacent winding turns. A laminated winding for an electrical machine is also disclosed, and includes a strip of conducting material. The strip is wound in a cylindrical manner and is provided with cuts which are located between winding turns of the laminated winding such that they together form continuous radial slots, wherein a radial distance is enclosed between adjacent winding turns.

### BACKGROUND AND SUMMARY

The present invention relates to method of producing a laminated winding with radial slots for electrical machines, to a laminated winding for an electrical machine produced according to that method, to an electrical machine having such a laminated winding and a vehicle being provided with such an electrical machine.

Today there is a need for electrical machines that for extended periods of time are able to convert several times more power than its continuous specified power, also called nominal power. The nominal power in combination with the cooling method normally determines the weight and space of the machine. Shorter periods of operation at power levels higher than the nominal power are handled by heating of the thermal mass of the machine. This is not least relevant for electrically driven vehicles and hybrid vehicles where the need for several times higher power than the nominal power during a limited time period happens for example in extended acceleration or in longer time driving uphill. In such cases the heating of the thermal mass of the machine may not be enough to handle the extended period of operation time at very high power, even if the machine electromagnetically is able to provide the power, and thus alternative cooling concepts must be used.

As an example a 20 ton commercial Plug In Hybrid Electric Vehicle (HEV) can be mentioned, in which the average electric power need in electric mode over an entire drive cycle is around 60 kW, while the intermittent peak operation preferably should be at least twice as high.

Cooling of the electrical machine is needed to remove the heat which is produced in it when currents are forced through the material. These currents give rise to resistive heat losses in the material. Cooling generally takes place through conduction, convection and radiation with our without any forced cooling. The efficiency and magnitude of these effects are dependent on the design of the electrical machine and on the presence of any forced cooling.

Laminated windings may be used in the electrical machine. They have a naturally high fill-factor compared to normally wound machines. Laminated windings may be three quarter windings for which a strip may be rolled and glued to a cylinder before slots are made with cutting or milling. A very high fill-factor is thus achieved. Such a method of production leaves the three quarter winding with an increased shortcut risk between the winding turns in each slot after the milling or cutting of the slot, and the slot sides thereby needs to be polished.

It is known to cool a winding by using a gas medium such as air flowing through the spacing in a winding. The winding design in an air core machine does not achieve the possibility to have a dense laminated iron core in the machine which would hinder the cooling with a radial air flow through the winding except for the end turns. Furthermore, placing a fan radially outside the machine will severely increase the size of the machine.

There is a need for improving the production method of laminated windings and the laminated windings themselves for electrical machines.

According to one aspect a method of producing a cylindrical laminated winding with radial slots for electrical machines is disclosed. The method includes providing a strip of conducting material, cutting cuts in a strip where the cuts form the radial slots of the laminated winding, and winding the strip to form the cylindrical laminated winding whereby a radial distance is enclosed between adjacent winding turns.

Hereby an efficient way of producing a laminated winding is achieved which also results in an efficient and purposeful cylindrical laminated winding. Through this production method it becomes possible to cool the laminated winding during its use, such that excessive heat may be removed and the electrical machine, in which the laminated winding is used, may be used at higher power for a longer period of time, or may be designed smaller in relation to known ones. This in turn leads to more cost efficient electrical machine.

The step of cutting cuts in the strip may be made through punching, which is a simple yet precise production method.

The step of cutting cuts may include cutting the cuts alternatingly from either side of the strip, thereby forming a wave-like laminated winding.

The step of cutting the cuts may include calculating individual distances between adjacent cuts. Through controlling the individual distances the radial distances between winding turns may be controlled.

The step of cutting cuts may include increasing a dstance between adjacent cuts for each winding turn of the laminated winding. Hereby radial slots are created into which teeth of the iron core of an electrical machine may be positioned.

The step of cutting cuts in the strip may be preceded by the step of cutting the strip to a desired width.

The step of winding the strip may include providing the cuts in adjacent winding turns such that continuous radial slots are achieved.

The step of cutting cuts may be followed by a step of smoothing edges of the strip, particularly edges of the cuts, whereby the risk for short-cutting winding turns is reduced.

According to one aspect a cylindrical laminated winding for an electrical machine is disclosed. The laminated winding is produced and given the advantages according to the method disclosed above.

According to one aspect a laminated winding for an electrical machine is disclosed, which comprises a strip of conducting material. The strip is wound in a cylindrical manner and is provided with cuts which are located between winding turns of the laminated winding such that they together form continuous radial slots, wherein a radial distance is enclosed between adjacent winding turns.

Conventionally cooled electrical machines are thermally designed close to peak power. These machines are oversized to be able to handle the thermal strain. An electrical machine provided with a laminated winding of the present disclosure may instead be thermally designed for average power and will still be able to handle the strain from longer periods of peak power. The result is a significantly smaller electrical machine which will still have the same performance as the conventionally cooled machine.

In the above-mentioned example of the 20 tonnes HEV commercial vehicle the cost for hybrid drive may be compensated with an increase in power output from the electrical machine during longer periods of time, which are much longer than earlier possible. This can be achieved without increasing the machine size or weight.

The cuts may be provided in a transversal manner from either side of the strip.

The cuts may be provided alternatingly from either side of the strip.

Angles in the strip may be formed with a curvature in order to reduce the dielectric weakness.

The conducting material may be chosen from the group of copper alloys and aluminium alloys.

The laminated winding may have a fill-factor of above 50%, preferably above 60%.

The distance between adjacent cuts may increase with every winding turn.

A cross-sectional area of the strip may vary along the strip.

The radial distance between winding turns may generally be equal between different winding turns Hereby a more efficient cooling of the laminated winding is achieved, since the resistance against the forced cooling will be the same between the radial distances.

According to one aspect an electrical machine is disclosed which is provided with at least one laminated winding according the disclosure above.

The electrical machine may comprise three laminated windings, each one representing one phase of the electrical machine.

The electrical machine may be arranged to receive an axially flowing cooling media. The cooling of the electrical machine thus mainly takes place through convection along the axial length of the electrical machine in the radial distances between the winding turns of the laminated winding.

The electrical machine may include a cooling fan. Such a cooling fan may e.g. be used at times of peak power of the electrical machine such that the cooling is increased and the electrical machine may be subjected to peak power for a longer period of time, or to higher peak power without overheating the machine. The electrical machine may be cooled without the cooling fan at lower power levels.

The electrical machine may be of a radial flux type.

According to one aspect a vehicle is disclosed which is provided with an electrical machine according to the disclosure above.

### BRIEF DESCRIPTION OF THE DRAWINGS

In the following the disclosure will be visualized through the accompanying drawings, in which

FIG. 1 is a perspective view of a laminated winding during winding,

FIG. 2 is a partial magnification of a detail of the laminated winding of FIG. 1,

FIG. 3 is a partial top view of a part of the laminated winding of FIG. 1, and

FIG. 4 is a graph showing the cooling effect over time for different current densities and air speeds for the laminated winding of FIG. 1.

### DETAILED DESCRIPTION OF THE DRAWINGS

A non-limiting example of a laminated winding will not be described with reference to the accompanying drawings.

The present disclosure generally relates to an electrical machine having a dense laminated iron core. An iron core would normally hinder the cooling with a radial air flow through the winding except for at the end turns. Placing a fan radially outside the electrical machine would normally severely increase the size of the machine, which machines with the presently disclosed laminated winding do not need.

The disclosed cylindrical laminated winding is used with the iron core in the stator of the electrical machine. The iron core carries the alternating magnetic field. The iron core may e.g. be made from either laminated steel, from soft magnetic compound (SMC) or from soft magnetic mouldable compound (SM²C) Teeth of the iron core will be located in the slots in the laminated winding. Each laminated winding form one phase of the electrical machine, such that a three-phase electrical machine would have three axially distributed and separated laminated windings of the disclosed kind. The axial separation is made in order to prevent mutual flux between the phases. The parts of the laminated winding being directed in the axial direction of the laminated winding make up the poles which interact with the magnetic core of the electrical machine.

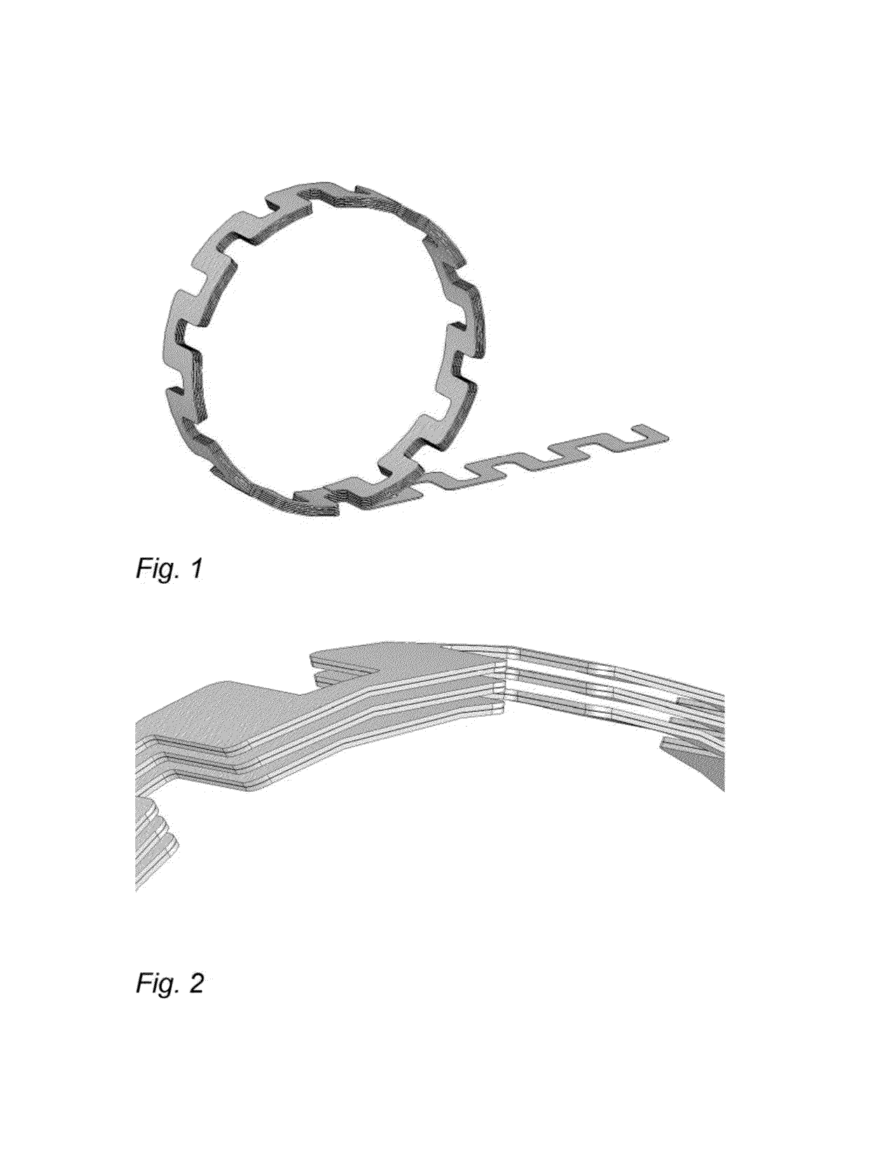

In FIGS. 1 and 2 an example of a cylindrical laminated winding according to the present disclosure is shown. The laminated winding is made from a strip of a conducting material. The strip is preferably made of either copper or aluminium, or alloys comprising either one of these materials. Aluminium may however have a density and cost advantage to copper, and an increased difference in resistivity between the two materials provides a natural defence against eddy current losses with increased electric frequency. The increase in DC resistance for aluminium is however a drawback since a laminated winding made of aluminium consequently needs an increased fill-factor (will be defined below) if left without an increased cooling capability in comparison with a corresponding laminated winding made of copper.

The strip may be provided with isolating layers such that there will not be any short-cutting between different winding turns of the laminated winding. The isolating layers may for an aluminium strip be made through enhancing the natural oxidation of the conductive material. This results in very thin isolating layers.

The general method of producing the laminated winding is shown in FIG. 1. The structure itself can be seen in more detail in FIG. 2. The laminated winding is manufactured through providing a strip of conducting material which is given a desired length and width to achieve the desired design of the laminated winding. The length of the strip in combination with the thickness of the strip and of the radial distance between the later discussed winding turns corresponds to the diameter and thickness of the wound laminated winding, and the width of the strip corresponds to the axial length of the wound laminated winding. The strip may be made from either a sheet or plate material.

Cuts are made in the strip by preferably punching the cuts alternatingly from either side of the strip having an extension transversally to the length of the strip, such that a wave like, or meandering shape is achieved. Corners or angles of the punched strip are preferably made smooth or rounded, Such rounded corners may preferably be made in the punching step, such that the punching device includes this feature if needed edges of the strip may be smoothed to reduce any risk for short-circuiting of the final laminated winding.

The laminated winding is given its final shape through winding the cut strip into a generally cylindrical roll in such a way that the individual cuts are arranged in an overlapping manner in the final laminated winding. The strip is hence pre-cut to the winding step. The step of winding the laminated winding is in each winding increment made around an axis which lies within the plane of the strip in a direction transversal to its axial length. In other words, the step of winding the laminated winding is made with the strip lying flat. The resulting cylindrical laminated winding is consequently laminated in the radial direction. The step of winding the laminated winding is made such that a distance in radial direction of the cylindrical roll is achieved between each winding turn. In other words, each winding turn is made up of the strip in combination with the radial distance. This can be seen in more detail in FIG. 2. It is noted that the radial distance between winding turns is present all along the strip in the whole laminated winding. It is preferable that the radial distance is continuous and of equal size along the whole strip, since it provides best cooling properties and thereby the most efficient electrical machine.

As has already been described, the cuts define the slots in the final laminated winding. The cuts are located such that they end up in the laminated winding on top of each other such that the radial slots form a continuous passage in the radial direction of the laminated winding. The cuts are made prior to winding of the cylindrical roll which ultimately turns into the laminated winding. The cuts are made with individual distances between them, i.e. with individual distances in the lengthwise direction of the strip, or in other words between adjacent cuts. The reason for doing so is that when the strip is wound up to a final laminated winding, it gives the possibility to control the distance between the winding turns, i.e. it gives the possibility to control the radial distance between the winding turns. Stated differently, by defining the individual distances between adjacent cuts the diameter of the laminated winding is decided. The distance between the cuts increases with every turn of the winding when the windings diameter increases, to be able to form the winding slot when the winding is wound up.

When the conducting strip with its cuts, which make up the slots, is punched before it is wound up, there is a possibility to incorporate this radial distance between each winding turn. This would be generally impossible if instead winding the un-cut strip and later adding the slots to the winding. The cost of incorporating the radial distance between winding turns will be at copper or aluminium fill-factor, i.e. electrical conducting material fill-factor. Fill-factor is often defined as the thickness of the strip multiplied with the number of winding turns divided with the total height of the stack of winding turns. A high fill-factor is generally acknowledged to increase the torque of the electrical machine. including the radial distance between the winding turns thus reduces the fill-factor. Normal laminated windings often have a fill-factor below 50%, but laminated windings of the kind of this disclosure may achieve higher fill-factor, for example above 60%, which increases the torque of the electrical machine and the possibility to cool the winding more efficiently, which in turn further increases the torque. The gain will consequently be the ability to press the cooling medium through the finished winding and get a more effective cooling inside the winding where the losses appear. The greater the radial distance, the better the cooling efficiency becomes. The cost of conducting fill-factor is not a problem, at least to a certain range, since the laminated winding has a naturally high fill-factor. With this production method there is also the possibility to design where in the windings the cooling is going to be applied by controlling the distance between adjacent cuts to create one or several larger gaps distributed in the winding where the cooling medium is flowing through to cool the laminated winding.

The radial distance between the winding turns is a factor affecting the power needed for a fan or similar device used to cool the laminated winding. The fan forces air through the space created by the radial distance between the winding turns, thereby withdrawing and transporting heat from the surfaces of the strip through mainly convection. With smaller radial distances between winding turns the pressure drop in the space created by the radial distances is increased, which necessitates a greater power for the fan for a corresponding cooling effect. The strip thickness and the radial distance are thus two factors that should be optimised for a certain application of the electrical machine in which the laminated winding should be used.

Similarly, the axial length of the laminated winding affects the cooling efficiency. The cooling efficiency is increased with an increased axial length since the air-wetted area is increased, whereas the pressure drop is also increased with axial length. Since an increased pressure drop may indicate a need for a stronger fan, the gain in cooling for a longer laminated winding is counteracted by the need for power to the fan. Here consequently also a need may arise for optimisation of the particular application of the electrical machine.

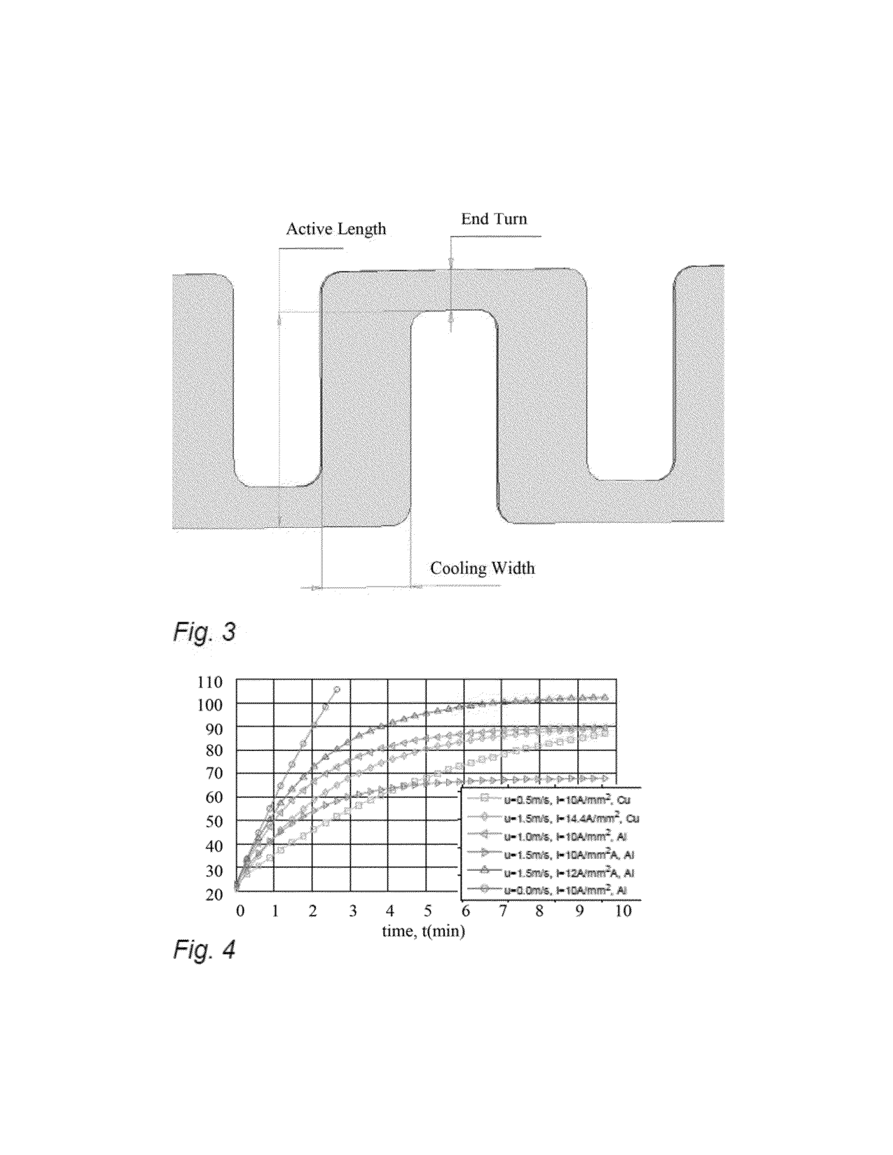

When designing for cooling efficiency it has been found that a wider cooling width increases the cooling effect. The width in FIG. 3 is the width of the wave like laminated winding. However, the cooling width is i.e. affected also by the number of poles needed for the electrical machine and the width of the teeth of the iron core, such that the cooling width is not only determined by its cooling efficiency.

In general a rather short laminated winding is found efficient, although effects of magnetic capability and torque requirements also may be taken into account and affecting the final machine design. Another advantage with a relatively seen short machine is that it has been found to be less sensitive to unevenly distributed radial distances between winding turns.

Typical designs of the laminated winding for air-cooled electrical machines include a generator having 20 poles and 12 winding turns. The axial length of the laminated winding is 25 mm, the inner radius is 58 mm and the outer radius is 69 mm. The thickness of the strip is 0.5 mm and the radial distance between winding turns is 0.25 mm. The width of each cut, i.e. measured in the same direction as the axial direction of the strip, is 9 mm. The teeth of the iron core in the electrical machine thus are preferably also 9 mm wide in order to minimise air flow leakage and hence cooling losses. The depth of each cut, i.e. measured in the transversal direction of the strip, is 16 mm.

Another example is an electrical machine for a wheel chair of 200 W. Such a machine could have a laminated winding having 22 poles and 17 winding turns of 0.5 mm thick strip. An axial length could be 28 mm, an inner radius of 66 mm and an outer radius of 79 mm. The width of the cuts could be 11 mm and the depth of the cuts 8.5 mm.

A third example machine could be an 80 kW electrical machine intended for a city bus. Such a machine could have a laminated winding having 6 poles and 12 winding turns of 0.8 mm thick strip. An axial length could be 100 mm, an inner radius of 63 mm and an outer radius of 79 mm. The width of the cuts could be 42.4-48.0 mm and the depth of the cuts 20.4-26.0 mm.

The possibility to get an effective cooling directly in the laminated winding makes it possible to increase the active length of the electric machine by minimizing the winding end turns. This is not possible to do with an ordinary winding made of continuous round conductors. In this disclosure a varying conductor cross section area is accomplished by choosing different area of the conducting cross sections of the winding with e.g. one size of the winding where the cooling is applied and another one in the end turns of the winding. From FIG. 3 it can be gleaned that the cross section area is represented by the thickness of the strip and the width at leach location of the wave like winding. The axial length of the laminated winding is defined by the width of the strip, which in turn is defined by the sum of the active length of the laminated winding and the width of the end turn. The width of the end turn is smaller than the cooling width. The thermal stress in the end turns is increased, but this is not a problem as the heat transportation to the cooling area is fast.

The cooling graphs disclosed in FIG. 4 show running of an electric machine of the first kind disclosed above having winding materials of either aluminium or copper. The test set-up includes either not adding any forced cooling (an air speed of 0 m/s) or several different air speeds, These forced air speeds range from 0.5 to 1.5 m/s. The test set-up is run with current densities of 10-14.4 A/mm². From FIG. 4 it can be gleaned that a lower temperature is achieved in the laminated winding when subjecting it to forced air cooling. This lowered temperature hence makes it possible to run the electrical machine at high power for extended periods of time without reaching temperatures which may damage the electrical machine.

The risk for short-cutting the winding turns, which is described above, can be avoided by removing the burr developed during the punching with brushing or graining before the strip is wound up to a laminated winding. This also saves time and minimizes cost in the production of the laminated winding.

Dielectric weakness of sharp angles at the end of each winding slot may be reduced by adding a radius at the end of the winding slot during punching of the strip. This is not as easy to do when cutting or milling a wound up cylinder due to the risk of harming the winding by flaking up the winding turns.

Further modifications of the disclosure within the scope of the appended claims are feasible. As such, the present disclosure should not be considered as limited by the embodiments and figures described herein. Rather, the full scope of the disclosure should be determined by the appended claims, with reference to the description and drawings.

The laminated winding of the present disclosure may be used not only in a stator in an electrical machine, but also in a rotor.

In order to achieve equal distances between winding turns of the laminated winding, small distance creating devices may be applied to the strip before winding. These distance creating devices should interfere with the cooling of the laminated winding to as little extent as possible, and small columns or pillars of non-conducting material could be evenly distributed along the length of the strip.

An alternative to a cooling fan may be a suction pump or similar device.

1. A method of producing a cylindrical laminated winding with radial slots for electrical machines, the method including:
providing a strip of conducting material,
cutting cuts in a strip where the cuts form the radial slots of the laminated winding, and
winding the strip to form the cylindrical laminated winding whereby a radial distance is enclosed between adjacent winding turns.

2. A method according to claim 1, wherein the step of cutting cuts in the strip is made through punching.

3. A method according to claim 1, wherein the step of cutting cuts includes cutting the cuts alternatingly from either side of the strip, thereby forming a wave-like laminated winding.

4. A method according to claim 1, wherein the step of cutting the cuts includes calculating individual distances between adjacent cuts.

5. A method according to claim 4, wherein the step of cutting cuts includes increasing a distance between adjacent cuts for each winding turn of the laminated winding.

6. A method according to claim 1, wherein the step of cutting cuts in the strip is preceded by the step of cutting the strip to a desired width.

7. A method according to claim 1, wherein the step of winding the strip includes providing the cuts in adjacent winding turns such that continuous radial slots are achieved.

8. A method according to claim 1, wherein the step of cutting cuts is followed by a step of smoothing edges of the strip, particularly edges of the cuts.

9. A cylindrical laminated winding for an electrical machine, the laminated winding being produced according to the method according to claim 1.

10. A laminated winding for an electrical machine, comprising a strip of conducting material, the strip being wound in a cylindrical manner and being provided with cuts which are located between winding turns of the laminated winding such that they together form continuous radial slots, wherein a radial distance is enclosed between adjacent winding turns.

11. A laminated winding according to claim 10, wherein the cuts are provided in a transversal manner from either side of the strip.

12. A laminated winding according to claim 10, wherein the cuts are provided alternatingly from either side of the strip.

13. A laminated winding according to claim 10, wherein angles in the strip are formed with a curvature.

14. A laminated winding according to claim 10, wherein the conducting material is chosen from the group of copper alloys and aluminium alloys.

15. A laminated winding according to claim 10, wherein the laminated winding has a fill-factor of above 50%, preferably above 60%.

16. A laminated winding according to claim 10, wherein the distance between adjacent cuts increase with every winding turn.

17. A laminated winding according to claim 10, wherein a cross-sectional area of he strip varies there along the strip.

18. A laminated winding according to claim 10, wherein the radial distance is generally equal between different winding turns.

19. An electrical machine being provided with at least one laminated winding according to any claim 10.

20. An electrical machine according to claim 19, comprising three laminated windings, each one representing one phase of the electrical machine.

21. An electrical machine according to claim 19, being arranged to receive an axially flowing cooling media.

22. An electrical machine according to claim 19, wherein the electric machine includes a cooling fan.

23. An electrical machine according to claim 19, the electrical machine being of a radial flux type.

24. A vehicle being provided with an electrical machine according to claim 19.
